(19) United States
(12) Patent Application Publication
(10) Pub. No.: US 2023/0214184 A1
(43) Pub. Date: Jul. 6, 2023

(54) CALCULATING DEVICE, CALCULATION PROGRAM, AND CALCULATION METHOD

(71) Applicant: KABUSHIKI KAISHA TOSHIBA, Tokyo (JP)

(72) Inventor: Hayato GOTO, Kawasaki Kanagawa (JP)

(73) Assignee: KABUSHIKI KAISHA TOSHIBA, Tokyo (JP)

(21) Appl. No.: 17/822,655

(22) Filed: Aug. 26, 2022

(30) Foreign Application Priority Data
Jan. 5, 2022 (JP) 2022-000406

(51) Int. Cl. G06F 7/544

(52) U.S. Cl. CPC G06F 7/544

(57) ABSTRACT

According to one embodiment, a calculating device includes a processor configured to perform repeating an update processing. The update processing includes update of first and second variable sets. The first variable set includes a first variable xᵢ. The second variable set includes a second variable yᵢ. The update of the second variable set includes updating the second variable yᵢ by adding a second function Fᵢ to the second variable yᵢ before the update. The second function Fᵢ includes the first variable xᵢ as a variable. The second function Fᵢ includes a parameter aᵢ. An ordinal number p is one integer not less than 1 and not more than N. An ordinal number q is one integer not less than 1 and not more than N. The ordinal number q is different from the ordinal number p. A parameter aₚ is different from a parameter a_{q}.

### CROSS-REFERENCE TO RELATED APPLICATIONS

This application is based upon and claims the benefit of priority from Japanese Patent Application No. 2022-000406, filed on Jan. 5, 2022; the entire contents of which are incorporated herein by reference.

### FIELD

Embodiments described herein relate generally to a calculating device, a calculation program, and a calculation method.

### BACKGROUND

An optimization problem or the like is solved by a calculating device. It is desirable to increase the calculation accuracy of the calculating device.

### BRIEF DESCRIPTION OF THE DRAWINGS

FIG. 1 is a schematic view illustrating a calculating device according to an embodiment;

FIG. 2 is a flowchart illustrating an operation of the calculating device according to the embodiment;

FIG. 3 is a flowchart illustrating an operation of the calculating device according to the embodiment;

FIG. 4 is a schematic view illustrating a part of the calculating device according to the embodiment;

FIG. 5 is a schematic view illustrating a part of the calculating device according to the embodiment;

FIG. 6 is a schematic view illustrating a part of the calculating device according to the embodiment;

FIG. 7 is a flowchart illustrating an operation of the calculating device according to the embodiment;

FIG. 8 is a flowchart illustrating an operation of the calculating device according to the embodiment;

FIG. 9 is a flowchart illustrating an operation of the calculating device according to the embodiment;

FIG. 10 is a flowchart illustrating an operation of the calculating device according to the embodiment;

FIG. 11 is a graph illustrating calculation results of calculating devices; and

FIG. 12 is a graph illustrating calculation results of the calculating devices.

### DETAILED DESCRIPTION

According to one embodiment, a calculating device includes a processor configured to perform repeating an update processing. The update processing includes an update of a first variable set and an update of a second variable set. The first variable set includes a first variable xᵢ (the ordinal number i is an integer of 1 to N, and N is one integer not less than 2). The second variable set includes a second variable yᵢ. The update of the second variable set includes updating the second variable yᵢ by adding a second function Fᵢ to the second variable yᵢ before the update. The second function Fᵢ includes the first variable xᵢ as a variable. The second function Fᵢ includes a parameter aᵢ. An ordinal number p is one integer not less than 1 and not more than N. An ordinal number q is one integer not less than 1 and not more than N. The ordinal number q is different from the ordinal number p. A parameter aₚ is different from a parameter a_{q}.

Various embodiments are described below with reference to the accompanying drawings.

In the specification and drawings, components similar to those described previously or illustrated in an antecedent drawing are marked with like reference numerals, and a detailed description is omitted as appropriate.

### First Embodiment

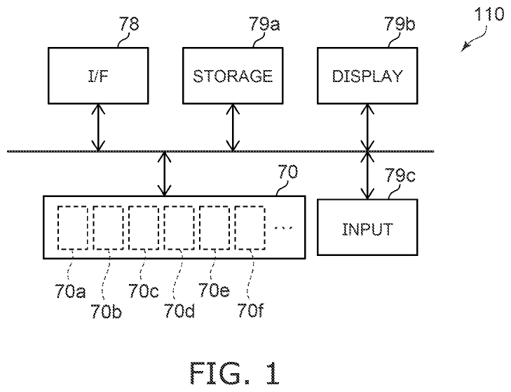

FIG. 1 is a schematic view illustrating a calculating device according to an embodiment.

As shown in FIG. 1, the calculating device 110 according to the embodiment includes a processor 70. As described below, the processor 70 is configured to repeatedly perform an update processing.

The processor 70 may include, for example, a CPU (Central Processing Unit), etc. The processor 70 includes, for example, an electronic circuit, etc. The calculating device 110 may be a calculation system.

In the example, the calculating device 110 includes an acquisition part 78. For example, the acquisition part 78 is configured to acquire various data. The acquisition part 78 includes, for example, an I/O port, etc. The acquisition part 78 is an interface. The acquisition part 78 may include the function of an output part. The acquisition part 78 may include, for example, a communication function.

In the example, the calculating device 110 includes storage 79a. The storage 79a is configured to store various data. The storage 79a may be, for example, memory. The storage 79a may include at least one of ROM (Read Only Memory) or RAM (Random Access Memory).

The calculating device 110 may include a display part 79b, an input part 79c, etc. The display part 79b may include various displays. The input part 79c includes, for example, a device (e.g., a keyboard, a mouse, a touch input panel, a speech recognition input device, etc.) that includes an operation function.

Multiple components that are included in the calculating device 110 can communicate with each other by at least one of wired or wireless methods. The locations at which the multiple components included in the calculating device 110 are located may be different from each other. For example, a general-purpose computer may be used as the calculating device 110. For example, multiple computers that are connected to each other may be used as the calculating device 110. A dedicated circuit may be used as at least a part of the calculating device 110 (e.g., the processor 70, etc.). For example, multiple circuits that are connected to each other may be used as the calculating device 110.

As shown in FIG. 1, the processor 70 may include multiple processing parts (e.g., first to sixth processing parts 70a to 70f, etc.). The multiple processing parts may operate in parallel. For example, parallel processing (parallel computation) may be performed.

Examples of operations performed by the calculating device 110 according to the embodiment will now be described.

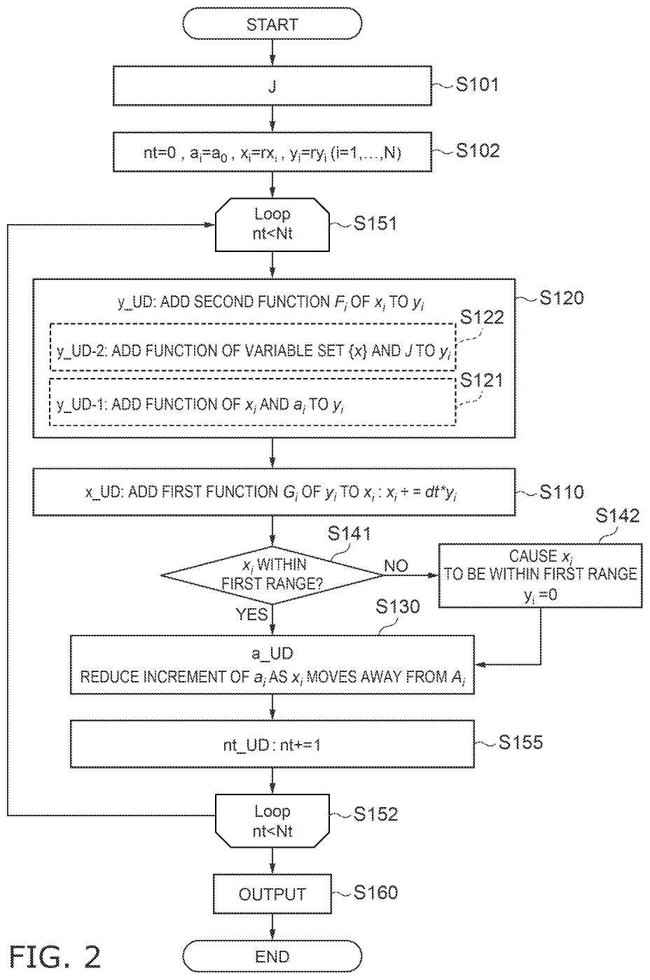

FIG. 2 is a flowchart illustrating an operation of the calculating device according to the embodiment.

FIG. 2 illustrates an operation performed by the processor 70. The processor 70 is configured to repeatedly perform an update processing. The update processing is repeatedly performed by the loop of steps S151 and S152.

The update processing includes an update x_UD of a first variable set (step S110) and an update y_UD of a second variable set (step S120). In the example, step S110 is performed after step S120 in one update processing.

The first variable set includes a first variable xᵢ. The ordinal number i is an integer of 1 to N. “N” is one integer not less than 2. The first variable xᵢ corresponds to the ith element of the first variable set {x}. The second variable set includes a second variable yᵢ. The second variable yᵢ corresponds to the ith element of the second variable set {y}.

The update y_UD of the second variable set (step S120) includes updating the second variable yᵢ by adding a second function Fᵢ to the second variable yᵢ before the update. The second function Fᵢ includes the first variable xᵢ as a variable. For example, the second function Fᵢ is a function of the first variable xᵢ. The second function Fᵢ includes a parameter aᵢ.

The second function Fᵢ may include a first-term function and a second-term function. For example, the second function Fᵢ includes the sum of the first-term function and the second-term function. The update y_UD of the second variable set includes an update y_UD-1 based on the first-term function and an update y_UD-2 based on the second-term function.

The first-term function includes the first variable xᵢ and the parameter aᵢ as variables. In other words, the first-term function is a function that includes the first variable xᵢ and the parameter aᵢ. The update y_UD-1 based on the first-term function includes, for example, adding the first-term function including the first variable xᵢ and the parameter aᵢ to the second variable yᵢ before the update (step S121).

The second-term function includes the first variable set {x} and a first parameter set {J} as variables. In other words, the update y_UD-2 based on the second-term function includes, for example, adding the second-term function of the first variable set {x} and the first parameter set {J} to the second variable yᵢ before the update (step S122). Step S121 may be performed after step S122. Step S122 may be performed after step S121.

On the other hand, the update x_UD of the first variable set (step S110) includes updating the first variable xᵢ by adding a first function Gᵢ to the first variable xᵢ before the update. The first function Gᵢ includes the second variable yᵢ as a variable. For example, the update x_UD of the first variable set (step S110) includes adding the first function Gᵢ of the second variable yᵢ to the first variable xᵢ before the update.

As described above, the second function Fᵢ that is used in the update y_UD of the second variable set includes the parameter aᵢ. The parameter aᵢ is, for example, a bifurcation parameter. According to the embodiment, the parameter aᵢ for one ordinal number i is different from the parameter aᵢ for another ordinal number i. For example, the ordinal number p is one integer not less than 1 and not more than N. The ordinal number q is one integer not less than 1 and not more than N. The ordinal number q is different from the ordinal number p. According to the embodiment, the parameter aₚ is different from the parameter a_{q}. For example, a highly-accurate calculation result is obtained by such a parameter aᵢ.

In a reference example, the same parameter aᵢ is applied to all in ordinal number i. For example, in the reference example, the same parameter aᵢ is applied to each loop of the update processing.

In contrast, according to the embodiment, different parameters aᵢ of at least two different ordinal numbers i are applied. A highly-accurate calculation result is obtained thereby.

According to the embodiment, different parameters aᵢ are applicable to each loop of the update processing. For example, each loop of the update processing includes a first update and a second update. The second update is performed after the first update. The parameter aᵢ of the second update may be different from the parameter aᵢ of the first update. The parameter aₚ of the second update may be different from the parameter aₚ of the first update. The parameter a_{q} of the second update may be different from the parameter a_{q} of the first update. For example, according to the embodiment, the parameter aᵢ is updated. A calculation result of even higher accuracy is obtained thereby.

Several examples related to the update (the modification) of the parameter aᵢ will now be described.

In the first example, when referenced to the initial parameter aᵢ, the parameter aᵢ is increased after the loop of the update processing (at the end of the calculation). For example, the processor 70 performs the update processing K times. “K” is an integer not less than 2. The parameter aᵢ of the Kth update processing is greater than the parameter aᵢ of the first update processing. In such a case, the increment of the parameter a; of the second update referenced to the parameter aᵢ of the first update is set to decrease as the absolute value of the difference between the first variable xᵢ and a first value Aᵢ increases.

In the first example, for example, the absolute value of the difference between the first variable xₚ and the first value Aₚ is greater than the absolute value of the difference between the first variable x_{q} and the first value A_{q}. In such a case, the increment of the parameter aₚ of the second update referenced to the parameter aₚ of the first update is set to be less than the increment of the parameter a_{q} of the second update referenced to the parameter a_{q} of the first update. Such processing is performed by the processor 70.

In a second example, when referenced to the initial parameter aᵢ, the parameter aᵢ is reduced after the loop of the update processing (at the end of the calculation). The parameter aᵢ of the Kth update processing is less than the parameter aᵢ of the first update processing. In such a case, the decrement of the parameter aᵢ of the second update referenced to the parameter aᵢ of the first update decreases as the absolute value of the difference between the first variable xᵢ and the first value Aᵢ increases.

In the second example, for example, the absolute value of the difference between the first variable xₚ and the first value Aₚ is greater than the absolute value of the difference between the first variable x_{q} and the first value A_{q}. In such a case, the decrement of the parameter aₚ of the second update referenced to the parameter aₚ of the first update is set to be less than the decrement of the parameter a_{q} of the second update referenced to the parameter a_{q} of the first update. Such processing is performed by the processor 70.

Thus, the parameter aᵢ is modified according to the first variable xᵢ. For example, the processor 70 controls the first variable xᵢ to be within a first range. The first range is not less than a first boundary value and not more than a second boundary value. The first value Aᵢ, the first value Aₚ, and the first value A_{q} described above are not more than the second boundary value of not less than the first boundary value. The first boundary value and the second boundary value correspond to the “walls” of the first range in which the first variable xᵢ is controlled.

For example, the first value Aᵢ may be a substantially median value of the first and second boundary values. The first value Aₚ and the first value A_{q} may be substantially median values of the first and second boundary values.

FIG. 2 shows the first example described above. As shown in FIG. 2, it is determined whether or not the first variable xᵢ is within the first range after steps S120 and S110 (step S141). When the first variable xᵢ is within the first range, the flow proceeds to step S130.

When the first variable xᵢ is not within the first range, the flow proceeds to step S142. Processing is performed in step S142 to cause the first variable xᵢ to be within the first range. The first variable xᵢ is returned to the first range. In step S142, for example, the second variable yᵢ is set to 0. Then, the flow proceeds to step S130.

An update a_UD of the parameter aᵢ is performed in step S130. In the first example, when referenced to the initial parameter aᵢ, the parameter aᵢ is increased after the loop of the update processing (at the end of the calculation). In the update a_UD of the parameter aᵢ of the first example, the increment of the parameter aᵢ is set to decrease as the first variable xᵢ moves away from the first value Aᵢ.

As shown in FIG. 2, the update processing that includes the update x_UD of the first variable set (step S110), the update y_UD of the second variable set (step S120), and the update a_UD of the parameter aᵢ are repeated inside a loop. For example, step S110, step S120, and step S130 are located between steps S151 and S152. In the example, steps S141 and S142 are located between steps S151 and S152.

As shown in FIG. 2, for example, the processor 70 acquires the problem data J (step S101). For example, the problem data J is input by a user of the calculating device 110. The acquisition part 78 acquires the problem data J that is input. The problem data J that is acquired by the acquisition part 78 is supplied to the processor 70. For example, the problem data J corresponds to the first parameter set {J}.

As shown in FIG. 2, the following initialization (step S102) is performed. For example, the variables and the parameters are initialized. For example, an iteration count nt is set to 0. For example, the parameter aᵢ is set to “a₀”. “a₀” is a determined value. For example, the first variable xᵢ is set to “rxᵢ”. The second variable yᵢ is set to “ryᵢ” in the initialization. “rxᵢ” and “ryᵢ” are mutually-independent random numbers.

Thereafter, the operation of the loop between steps S151 and S152 is performed until the iteration count nt reaches a determined value Nt. An example of the update y_UD of the second variable set (step S120) is described below.

For example, the following first formula is calculated in the update x_UD of the first variable set (step S110).

xᵢ+=dt*yᵢ (1)

In the first formula, “dt” is, for example, a constant. “dt” may be predetermined. The first formula indicates that the variable at the left side before the “+” is updated by adding the right side to the variable. This is similar for similar formulas illustrated below as well. The “asterisk (*)” is the multiplication symbol.

After step S110, the flow proceeds to step S155 via steps S141, S142, and S130 described above. The following second formula is performed in step S155.

nt+=1 (2)

In other words, the iteration count nt is increased by 1. When the iteration count nt is less than the determined value Nt in step S152, the flow returns to step S151. The calculation ends when the iteration count nt reaches the determined value Nt.

The processor 70 is configured to output at least the first variable xᵢ obtained after repeating the update processing and at least one function of the first variable xᵢ obtained after repeating the update processing (step S160).

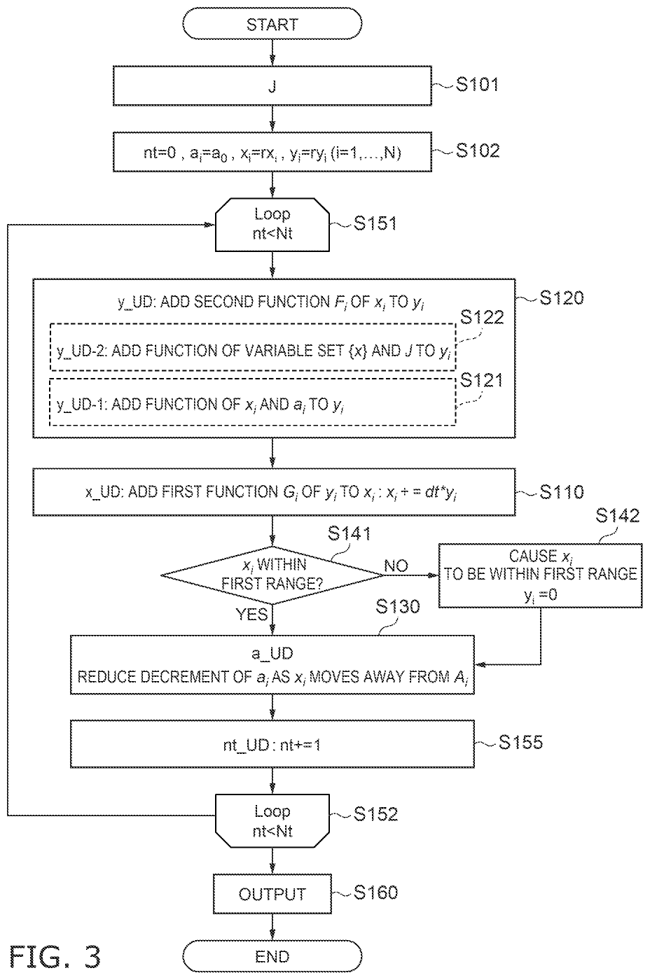

FIG. 3 is a flowchart illustrating an operation of the calculating device according to the embodiment.

FIG. 3 shows the second example described above. As shown in FIG. 3, the update a_UD of the parameter aᵢ is performed in step S130. In the second example, when referenced to the initial parameter aᵢ, the parameter aᵢ is reduced after the loop of the update processing (at the end of the calculation). In step S130 (the update a_UD of the parameter aᵢ) of the second example, the decrement of the parameter aᵢ is set to decrease as the first variable xᵢ moves away from the first value Aᵢ. Other than such a step S130, the processing illustrated in FIG. 3 may be similar to the processing illustrated in FIG. 2.

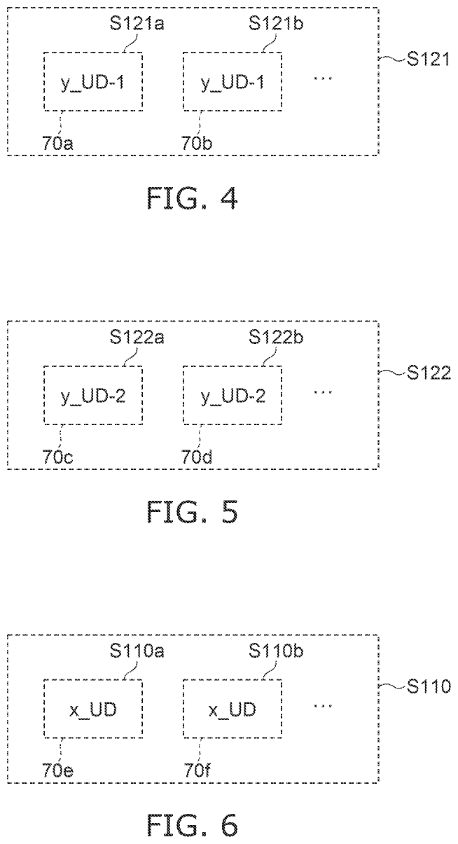

FIG. 4 is a schematic view illustrating a part of the calculating device according to the embodiment.

As shown in FIG. 4, the processor 70 may include the first processing part 70a and the second processing part 70b. The first processing part 70a and the second processing part 70b perform the update y_UD-1 based on the first-term function (step S121). For example, the first processing part 70a performs a part of the calculation related to the first-term function (step S121a). The second processing part 70b performs another part of the calculation related to the first-term function (step S121b). At least a portion of the other part of the calculation related to the first-term function may be simultaneously performed with at least a portion of the part of the calculation related to the first-term function. Parallel computation speeds up the calculation.

FIG. 5 is a schematic view illustrating a part of the calculating device according to the embodiment.

As shown in FIG. 5, the processor 70 may include the third processing part 70c and the fourth processing part 70d. The third processing part 70c and the fourth processing part 70d perform the update y_UD-2 based on the second-term function (step S122). For example, the third processing part 70c performs a part of the calculation related to the second-term function (step S122a). The fourth processing part 70d performs another part of the calculation related to the second-term function (step S122b). At least a portion of the other part of the calculation related to the second-term function may be simultaneously performed with at least a portion of the part of the calculation related to the second-term function. Parallel computation speeds up the calculation.

FIG. 6 is a schematic view illustrating a part of the calculating device according to the embodiment.

As shown in FIG. 6, the processor 70 may include the fifth processing part 70e and the sixth processing part 70f. The fifth processing part 70e and the sixth processing part 70f perform the update x_UD of the first variable set (step S110). For example, the fifth processing part 70e performs a part of the update x_UD of the first variable set (step S110a). The sixth processing part 70f performs another part of the update x_UD of the first variable set (step S110b). At least a portion of the other part of the update x_UD of the first variable set is simultaneously performed with at least a portion of the part of the update x_UD of the first variable set.

For example, the fifth processing part 70e performs a part of the calculation related to the first function Gᵢ (step S110a). The sixth processing part 70f performs another part of the calculation related to the first function Gᵢ (step S110b). At least a portion of the other part of the calculation related to the first function Gᵢ is simultaneously performed with at least a portion of the part of the calculation related to the first function Gᵢ.

Thus, the parallel processing (the parallel computation) for the ordinal number i may be performed in at least one of the update y_UD-1 based on the first-term function, the update y_UD-2 based on the second-term function, or the update x_UD of the first variable set. For example, the calculations related to mutually-different ordinal numbers i are performed in parallel. The optimization problem can be quickly calculated by parallel processing. For example, a large-scale problem can be quickly solved. For example, the values of the signs (−1 or 1) of the first variable xᵢ give the solution of the combinatorial optimization problem corresponding to the first parameter set {J}.

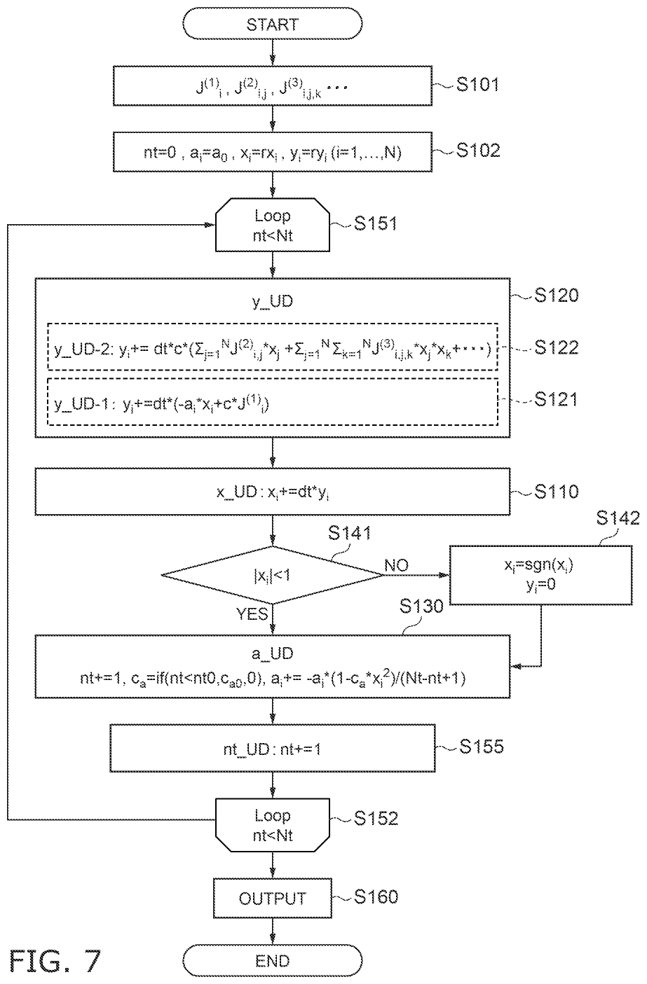

FIG. 7 is a flowchart illustrating an operation of the calculating device according to the embodiment.

FIG. 7 shows one example related to the second example described above. In the example of FIG. 7, the problem data J (the first parameter set {J}) may include first-, second-, third-, and higher-order tensors.

In the example of FIG. 7, the following third formula is calculated in the update y_UD-2 based on the second-term function.

yᵢ+=dt*c*(Σⱼ₌₁^{N}J⁽²⁾_{i,j}*xⱼ+Σⱼ₌₁^{N}Σₖ₌₁^{N}J⁽³⁾_{i,j,k}*xⱼ*xₖ+ (3)

As illustrated in the third formula, the first parameter set {J} includes first-, second-, third-, and higher-order tensors. The second-term function includes a multiply-add operation term of at least a part of the first parameter set {J} and at least a part of the first variable set {x}. When the first parameter set {J} is second-order, the first parameter set {J} corresponds to a matrix. Thus, the first parameter set {J} may include third- or higher-order tensors. In the third formula, “c” is a parameter. For example, “c” may be calculated between steps S151 and S120. Examples of “c” are described below.

The following fourth formula is calculated in the update y_UD-1 based on the first-term function.

yᵢ+=dt*(−aᵢ*xᵢ+c*J⁽¹⁾ᵢ) (4)

Namely, the first-term function that is included in the second function Fᵢ includes the product of the first variable xᵢ and the parameter aᵢ.

The following fifth formula is determined in step S141 in the example of FIG. 7.

|xᵢ|<1 (5)

When the fifth formula is satisfied in step S141, the flow proceeds to step S130. When the fifth formula is not satisfied in step S141, the flow proceeds to step S142. The following sixth formula is performed in step S142.

xᵢ=sgn(xᵢ),

yᵢ=0 (6)

In the sixth formula, “sgn(xᵢ)” represents the value of the sign (−1 or 1) of the first variable xᵢ. The “processing” of the sixth formula and various subsequent formulas may be represented using a programming language.

In the example of FIG. 7, the following seventh formula is calculated in step S130.

nt+=1,

cₐ=if(nt<nt0,c_{a0*}0),

aᵢ+=−aᵢ*(1−cₐ*xᵢ²)/(Nt−nt+1) (7)

In the seventh formula, “Cₐ”, “Cₐ₀”, and “nt0” are parameters. “Cₐ”, “Cₐ₀”, and “nt0” may be predetermined. A function that is defined in the following eighth formula is applied to the seventh formula.

if(A,a,b) (8)

When “A” is true, the value of the function of the eighth formula is “a” of the eighth formula. When “A” is false, the value of the function of the eighth formula is “b” of the eighth formula. The update a_UD of the parameter aᵢ is performed based on the seventh formula above.

In the example of FIG. 7, the following ninth formula may be calculated in step S122.

yᵢ+=dt*c*(Σⱼ₌₁^{N}J⁽²⁾_{i,j}*sⱼ+Σⱼ₌₁^{N}Σₖ₌₁^{N}J⁽³⁾_{i,j,k}*sⱼ*sₖ+ (9)

In the ninth formula, “sⱼ” in the second term inside the parentheses on the right side is represented by the following tenth formula.

sⱼ=sgn(xⱼ) (10)

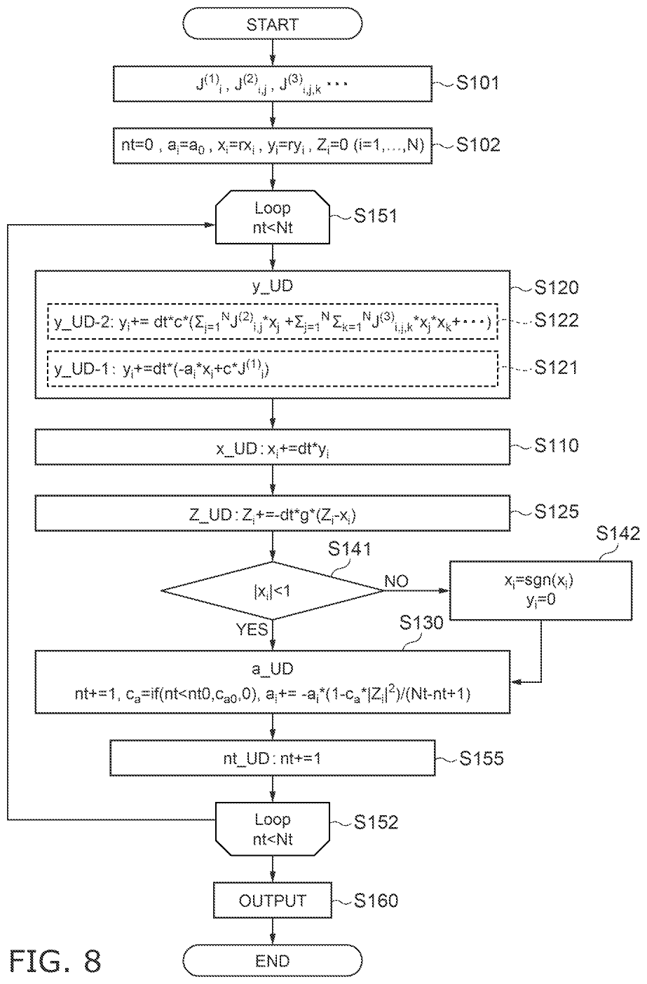

FIG. 8 is a flowchart illustrating an operation of the calculating device according to the embodiment.

In the example of FIG. 8, the parameter aᵢ is updated based on an average (e.g., a temporal average) of the first variable xᵢ.

As shown in FIG. 8, the following eleventh formula is calculated after step S110 (step S125).

Zᵢ+=−dt*g*(Zᵢ−xⱼ) (11)

In the eleventh formula, “g” is a constant. “g” may be predetermined. “Zᵢ” of the eleventh formula corresponds to the temporal average of the first variable xᵢ. In the example as shown in FIG. 8, “Zᵢ” is set to 0 in the initialization (step S102). Then, steps S141 and S142 described with reference to FIG. 7 are performed.

In the example of FIG. 8, the following twelfth formula is calculated in step S130.

nt+=1,

cₐ=if(nt<nt0,c_{a0*}0),

aᵢ+=−aᵢ*(1−cₐ*|Zᵢ|²)/(Nt−nt+1) (12)

Then, steps S155, S152, and S160 described with reference to FIG. 7 are performed. Thus, according to the embodiment, the parameter aᵢ may be updated based on the variable “Zᵢ”.

For example, in a third example, the processor 70 performs the update processing K times. The parameter aᵢ of the Kth update processing is greater than the parameter aᵢ of the first update processing. Each loop of the update processing includes the first update and the second update performed after the first update. The increment of the parameter aᵢ of the second update referenced to the parameter aᵢ of the first update is set to decrease as the absolute value of the difference between a variable Zᵢ and the first value Aᵢ increases for two ordinal numbers i. The variable Zᵢ changes dependently on the first variable xᵢ.

For example, in the third example, the absolute value of the difference between the variable Zₚ and the first value Aₚ is greater than the absolute value of the difference between the variable Z_{q} and the first value A_{q}. In such a case, the increment of the parameter aₚ of the second update referenced to the parameter aₚ of the first update is set to be less than the increment of the parameter a_{q} of the second update referenced to the parameter a_{q} of the first update. The variable Zₚ changes dependently on the first variable xₚ. The variable Z_{q} changes dependently on the first variable x_{q}.

For example, in a fourth example, the processor 70 performs the update processing K times. The parameter aᵢ of the Kth update processing is less than the parameter aᵢ of the first update processing. Each loop of the update processing includes the first update and the second update performed after the first update. The decrement of the parameter aᵢ of the second update referenced to the parameter aᵢ of the first update is set to decrease as the absolute value of the difference between the variable Zᵢ and the first value Aᵢ increases for two ordinal numbers i. The variable Zᵢ changes dependently on the first variable xᵢ.

For example, in the fourth example, the absolute value of the difference between the variable Zₚ and the first value Aₚ is greater than the absolute value of the difference between the variable Z_{q} and the first value A_{q}. In such a case, the decrement of the parameter aₚ of the second update referenced to the parameter aₚ of the first update is set to be less than the decrement of the parameter a_{q} of the second update referenced to the parameter a_{q} of the first update. The variable Zₚ changes dependently on the first variable xₚ. The variable Z_{q} changes dependently on the first variable x_{q}.

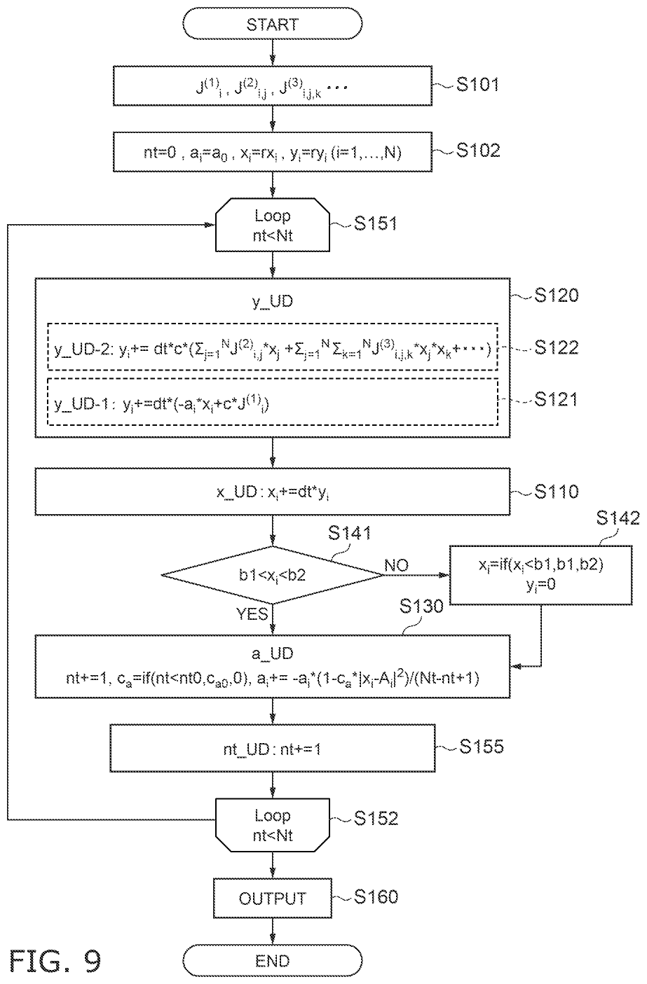

FIG. 9 is a flowchart illustrating an operation of the calculating device according to the embodiment.

In the example of FIG. 9, the parameter aᵢ is updated based on the distance to the first variable xᵢ from the first value Aᵢ.

In FIG. 9, the following thirteenth formula is determined in step S141.

b1<xᵢ<b2 (13)

In the thirteenth formula, “b1” corresponds to the first boundary value. “b2” corresponds to the second boundary value.

In FIG. 9, the following fourteenth formula is calculated in step S142.

xᵢ=if(xᵢ<b1,b1,b2),

yᵢ=0 (14)

In FIG. 9, the following fifteenth formula is calculated in step S130.

nt+=1,

cₐ=if(nt<nt0,c_{a0*}0)

aᵢ+=−aᵢ*(1−cₐ*|xᵢ−Aᵢ|²)/(Nt−nt+1) (15)

For example, in the fifteenth formula, “Aᵢ” may be represented by the following sixteenth formula.

Aᵢ=(b1+b2)/2 (16)

In the example as shown in the sixteenth formula, the first value Aᵢ (e.g., the first value Aₚ and the first value A_{q}) is the median value of the first boundary value (b1) and the second boundary value (b2).

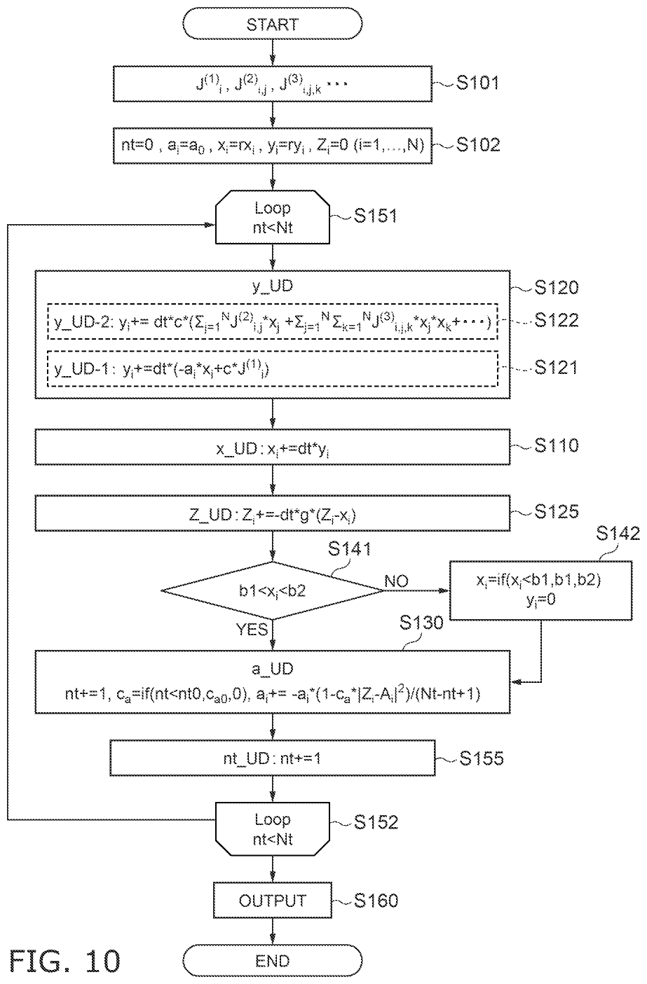

FIG. 10 is a flowchart illustrating an operation of the calculating device according to the embodiment.

In the example of FIG. 10, the parameter aᵢ is updated based on the distance from the first value Aᵢ and the temporal average of the first variable xᵢ.

In FIG. 10, the following seventeenth formula is calculated in step S130.

nt+=1,

cₐ=if(nt<nt0,cₐ₀,0),

aᵢ+=−aᵢ*(1−cₐ*|Zᵢ−Aᵢ|²)/(Nt−nt+1) (17)

According to the embodiment, various modifications of the update a_UD of the parameter aᵢ are possible.

According to the embodiment, an update that uses a random number may be performed. For example, the following eighteenth formula is calculated in the update y_UD-1 based on the first-term function (step S121).

yᵢ+=dt*(−rᵢ*aᵢ*xᵢ+c*J⁽¹⁾ᵢ) (18)

For example, the eighteenth formula is calculated instead of the fourth formula.

For example, the second function Fᵢ includes the first-term function. The first-term function includes the product of the first variable xᵢ, the parameter aᵢ, and the random number rᵢ. The random number rᵢ is positive. The random number rᵢ for one ordinal number i is different from the random number rᵢ for another ordinal number i. For example, the random number rₚ that is related to the ordinal number p is different from the random number r_{q} related to the ordinal number q. Such random numbers (noise terms) make it easier to separate the first variable xᵢ from the “walls” (the boundaries of the first range).

For example, the parameter “c” is obtained by the following nineteenth formula.

$$c = \sqrt{\frac{N}{{\sum }_{i = 1}^{N} {\vert {z}_{i} \vert}^{2}}} \\ {z}_{i} = {J}_{i}^{( 1 )} + {\sum }_{j = 1}^{N} {J}_{i , j}^{( 2 )} {x}_{j} + {\sum }_{j = 1}^{N} {\sum }_{k = 1}^{N} {J}_{i , j , k}^{( 3 )} {x}_{j} {x}_{k} + … \\ or \\ {z}_{i} = {J}_{i}^{( 1 )} + {\sum }_{j = 1}^{N} {J}_{i , j}^{( 2 )} {s}_{j} + {\sum }_{j = 1}^{N} {\sum }_{k = 1}^{N} {J}_{i , j , k}^{( 3 )} {s}_{j} {s}_{k} + … \qquad ( 19 )$$

The formulas above (e.g., the third formula, the fourth formula, etc.) are calculated using “c” obtained by the nineteenth formula.

Calculation examples will now be described.

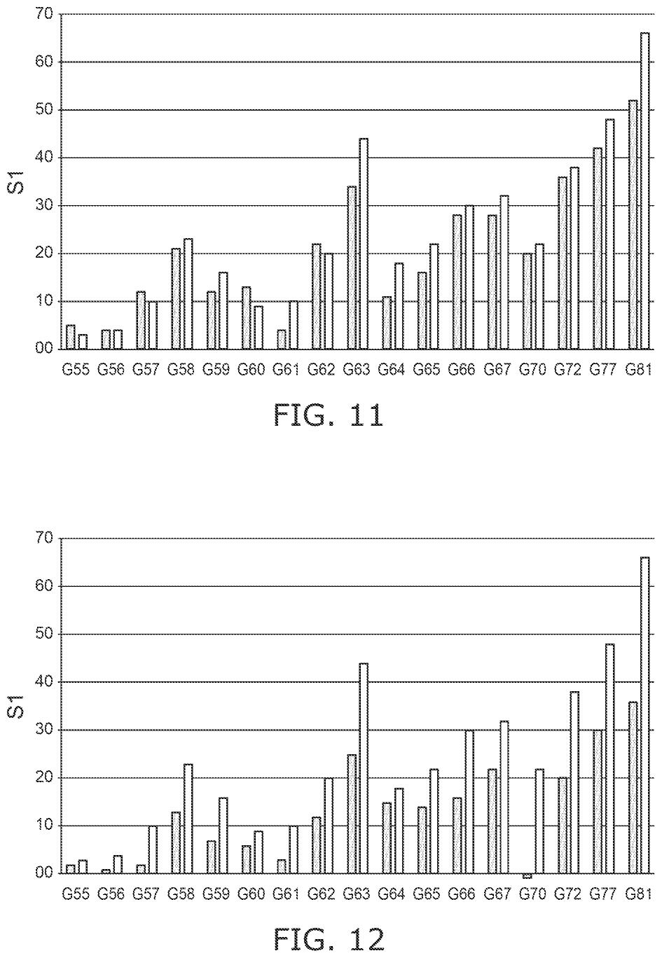

FIG. 11 is a graph illustrating calculation results of calculating devices.

In FIG. 11, the calculation result of the calculating device 110 according to the embodiment at a first calculation condition is shown by the dark bars. In FIG. 11, the calculation result of a calculating device according to a reference example is shown by the light bars. At the first calculation condition, different parameters aᵢ are applied for different ordinal numbers i as described above, and the parameter aᵢ is updated (modified) each loop of the update processing. In the calculating device of the reference example, the parameter aᵢ is the same for all in ordinal number i; and the parameter aᵢ is the same in each loop of the update processing. In the reference example, “cₐ” is 0. For the first calculation condition and the reference example, “rᵢ” is 1.

FIG. 11 shows the calculation results of the “G-set”. The “G-set” is a benchmark related to the maximum-cut problem. The horizontal axis of FIG. 11 is the instance name. The vertical axis of FIG. 11 is a precision parameter S1. The precision parameter S1 that is related to the embodiment corresponds to the difference between the cut value of the calculation result of the “best known values” related to the G-set and the cut value of the calculation result of the first calculation condition. The precision parameter S1 that is related to the reference example corresponds to the difference between the cut value of the calculation result of the “best known value” related to the G-set and the cut value of the calculation result of the calculation condition of the reference example. In the example, the “best known values” are described in “H. Goto et al., Science Advances 7, eabe7953 (2021)”. A small precision parameter S1 means that a solution of higher accuracy is obtained for the same calculation time. A small precision parameter S1 corresponds to a fast calculation.

At the first condition illustrated in FIG. 11, the parameter “cₐ” changes from 1.1 toward 0. As shown in FIG. 11, the calculating device 110 according to the embodiment resulted in a smaller precision parameter S1 than the reference example.

FIG. 12 is a graph illustrating calculation results of the calculating devices.

In FIG. 12, the calculation result of the calculating device 110 according to the embodiment at a second calculation condition is shown by the dark bars. In FIG. 12, the calculation result of the calculating device according to the reference example is shown by the light bars. At the second calculation condition, the parameter “cₐ” changes from 1.1 toward 0; and the random number (the noise term) of the eighteenth formula is applied. In the example, the random number rᵢ is a random number not less than 0.5 and not more than 1.5. As described above, in the reference example, “cₐ” is 0, and “rᵢ” is 1.

FIG. 12 shows the calculation result of the above “G-set”. The horizontal axis of FIG. 12 is the instance name. The vertical axis of FIG. 12 is the precision parameter S1. The precision parameter S1 that is related to the embodiment corresponds to the difference between the cut value of the calculation result of the “best known values” related to the G-set and the cut value of the calculation result of the first calculation condition. The precision parameter S1 that is related to the reference example corresponds to the difference between the cut value of the calculation result of the “best known value” related to the G-set and the cut value of the calculation result of the calculation condition of the reference example.

As shown in FIG. 12, the calculating device 110 according to the embodiment resulted in a smaller precision parameter S1 than the reference example.

### Second Embodiment

A second embodiment relates to a calculation program. The calculation program causes a computer to repeatedly perform the update processing described above.

### Third Embodiment

A third embodiment is a computer-readable recording medium. A program that causes a computer to repeatedly perform the update processing described above is recorded in the recording medium.

### Fourth Embodiment

The embodiment relates to a calculation method. The calculation method causes the processor 70 to repeatedly perform the update processing described above.

For example, the above processing (instructions) of the various information (data) is executed based on a program (software). For example, the above processing of the various information is performed by a computer storing the program and reading the program.

The above processing of the various information may be recorded in a magnetic disk (a flexible disk, a hard disk, etc.), an optical disk (CD-ROM, CD-R, CD-RW, DVD-ROM, DVD±R, DVD±RW, etc.), semiconductor memory, or another recording medium as a program that can cause a computer to perform the execution.

For example, the information that is recorded in the recording medium can be read by a computer (or an embedded system). The recording format (the storage format) of the recording medium is arbitrary. For example, the computer reads the program from the recording medium and causes a CPU to execute the instructions described in the program based on the program. In the computer, the acquisition (or the reading) of the program may be performed via a network.

At least a part of the above processing of the information may be performed by various software operating on a computer (or an embedded system) based on a program installed in the computer from a recording medium. The software includes, for example, an OS (operating system), etc. The software may include, for example, middleware operating on a network, etc.

The recording medium according to embodiments also includes a recording medium to which a program obtained using a LAN, the Internet, or the like is downloaded and stored. The above processing may be performed based on multiple recording media.

The computer according to embodiments includes one or multiple devices (e.g., personal computers, etc.). The computer according to embodiments may include multiple devices connected by a network.

Embodiments may include the following configurations (e.g., technological proposals).

### Configuration 1

A calculating device, comprising:

a processor configured to perform repeating an update processing,

the update processing including an update of a first variable set and an update of a second variable set,

the first variable set including a first variable xᵢ (the ordinal number i being an integer of 1 to N, and N being one integer not less than 2),

the second variable set including a second variable yᵢ,

the update of the second variable set including updating the second variable yᵢ by adding a second function Fᵢ to the second variable yᵢ before the update,

the second function Fᵢ including the first variable xᵢ as a variable,

the second function Fᵢ including a parameter aᵢ,

an ordinal number p being one integer not less than 1 and not more than N,

an ordinal number q being one integer not less than 1 and not more than N,

the ordinal number q being different from the ordinal number p,

a parameter aₚ being different from a parameter a_{q}.

### Configuration 2

The calculating device according to Configuration 1, wherein

the repeating of the update processing includes:
a first update; and
a second update performed after the first update, and

the parameter aₚ of the first update is different from the parameter aₚ of the second update.

### Configuration 3

The calculating device according to Configuration 2, wherein

the processor performs the update processing K times (K being an integer not less than 2),

the parameter aᵢ of the Kth update processing is greater than the parameter aᵢ of the first update processing,

an absolute value of a difference between the first variable xₚ and a first value Aₚ is greater than an absolute value of a difference between the first variable x_{q} and a first value A_{q}, and

an increment of the parameter aₚ of the second update referenced to the parameter aₚ of the first update is less than an increment of the parameter a_{q} of the second update referenced to the parameter a_{q} of the first update.

### Configuration 4

The calculating device according to Configuration 2, wherein

the processor performs the update processing K times (K being an integer not less than 2),

the parameter aᵢ of the Kth update processing is less than the parameter aᵢ of the first update processing,

an absolute value of a difference between the first variable xₚ and a first value Aₚ is greater than an absolute value of a difference between the first variable x_{q} and a first value A_{q}, and

a decrement of the parameter aₚ of the second update referenced to the parameter aₚ of the first update is less than a decrement of the parameter a_{q} of the second update referenced to the parameter a_{q} of the first update.

### Configuration 5

The calculating device according to Configuration 2, wherein

the processor performs the update processing K times (K being an integer not less than 2),

the parameter aᵢ of the Kth update processing is greater than the parameter aᵢ of the first update processing,

an absolute value of a difference between a variable Zₚ and a first value Aₚ is greater than an absolute value of a difference between a variable Z_{q} and a first value A_{q},

an increment of the parameter aₚ of the second update referenced to the parameter aₚ of the first update is less than an increment of the parameter a_{q} of the second update referenced to the parameter a_{q} of the first update,

the variable Zₚ changes dependently on the first variable xₚ, and

the variable Z_{q} changes dependently on the first variable x_{q}.

### Configuration 6

The calculating device according to Configuration 2, wherein

the processor performs the update processing K times (K being an integer not less than 2),

the parameter aᵢ of the Kth update processing is less than the parameter aᵢ of the first update processing,

an absolute value of a difference between a variable Zₚ and a first value Aₚ is greater than an absolute value of a difference between a variable Z_{q} and a first value A_{q},

a decrement of the parameter aₚ of the second update referenced to the parameter aₚ of the first update is less than a decrement of the parameter a_{q} of the second update referenced to the parameter a_{q} of the first update,

the variable Zₚ changes dependently on the first variable xₚ, and

the variable Z_{q} changes dependently on the first variable x_{q}.

### Configuration 7

The calculating device according to any one of Configurations 3 to 6, wherein

the processor controls the first variable xᵢ in a first range,

the first range is not less than a first boundary value and not more than a second boundary value, and

the first value Aₚ and the first value A_{q} are not less than the first boundary value and not more than the second boundary value.

### Configuration 8

The calculating device according to any one of Configurations 3 to 6, wherein

the processor controls the first variable xᵢ to be not less than a first boundary value and not more than a second boundary value, and

the first value Aₚ and the first value A_{q} are substantially median values of the first and second boundary values.

### Configuration 9

The calculating device according to any one of Configurations 3 to 8, wherein

the second function Fᵢ includes a first-term function, and

the first-term function includes a product of the first variable xᵢ and the parameter aₐ.

### Configuration 10

The calculating device according to any one of Configurations 1 to 9, wherein

the second function Fᵢ includes a first-term function,

the first-term function includes a product of the first variable xᵢ, the parameter aᵢ, and a random number rᵢ,

the random number rᵢ is positive, and

a random number rₚ related to the ordinal number p is different from a random number r_{q} related to the ordinal number q.

### Configuration 11

The calculating device according to Configuration 9 or 10, wherein

the second function Fᵢ includes the first-term function and a second-term function, and

the second-term function includes the first variable set and a first parameter set {J} as variables.

### Configuration 12

The calculating device according to Configuration 11, wherein

the second-term function includes a multiply-add operation term of at least a part of the first parameter set {J} and at least a part of the first variable set.

### Configuration 13

The calculating device according to Configuration 11 or 12, wherein

the first parameter set {J} includes third- or higher-order tensors.

### Configuration 14

The calculating device according to any one of Configurations 11 to 13, wherein

the processor includes a third processing part and a fourth processing part,

the third processing part performs a part of a calculation related to the second-term function,

the fourth processing part performs an other part of the calculation related to the second-term function, and

at least a portion of the other part of the calculation related to the second-term function is simultaneously performed with at least a portion of the part of the calculation related to the second-term function.

### Configuration 15

The calculating device according to any one of Configurations 9 to 14, wherein

the processor includes a first processing part and a second processing part,

the first processing part performs a part of a calculation related to the first-term function,

the second processing part performs an other part of the calculation related to the first-term function, and

at least a portion of the other part of the calculation related to the first-term function is simultaneously performed with at least a portion of the part of the calculation related to the first-term function.

### Configuration 16

The calculating device according to any one of Configurations 1 to 15, wherein

the update of the first variable set includes updating the first variable xᵢ by adding a first function to the first variable xᵢ before the update, and

the first function includes the second variable yᵢ as a variable.

### Configuration 17

The calculating device according to Configuration 16, wherein

the processor includes a fifth processing part and a sixth processing part,

the fifth processing part performs a part of a calculation related to the first function,

the sixth processing part performs an other part of the calculation related to the first function, and

at least a portion of the other part of the calculation related to the first function is simultaneously performed with at least a portion of the part of the calculation related to the first function.

### Configuration 18

The calculating device according to Configuration 16 or 17, wherein

the first function is independent of the first variable set, and

the second function is independent of the second variable set.

### Configuration 19

The calculating device according to any one of Configurations 1 to 18, wherein

the processor is configured to output at least the first variable xᵢ obtained after the repeating of the update processing and at least one function of the first variable xᵢ obtained after the repeating of the update processing.

### Configuration 20

A calculation program causing a computer to perform repeating an update processing,

the update processing including an update of a first variable set and an update of a second variable set,

the first variable set including a first variable xᵢ (the ordinal number i being an integer of 1 to N, and N being one integer not less than 2),

the second variable set including a second variable yᵢ,

the update of the second variable set including updating the second variable yᵢ by adding a second function Fᵢ to the second variable yᵢ before the update,

the second function Fᵢ including the first variable xᵢ as a variable,

the second function Fᵢ including a parameter aᵢ,

an ordinal number p being one integer not less than 1 and not more than N,

an ordinal number q being one integer not less than 1 and not more than N,

the ordinal number q being different from the ordinal number p, and

a parameter aₚ being different from a parameter a_{q}.

### Configuration 21

A recording medium in which a calculation program is recorded,

the recording medium being computer-readable,

the calculation program causing a computer to perform repeating an update processing,

the update processing including an update of a first variable set and an update of a second variable set,

the first variable set including a first variable xᵢ (the ordinal number i being an integer of 1 to N, and N being one integer not less than 2),

the second variable set including a second variable yᵢ,

the update of the second variable set including updating the second variable yᵢ by adding a second function Fᵢ to the second variable yᵢ before the update,

the second function Fᵢ including the first variable xᵢ as a variable,

the second function F including a parameter aᵢ,

an ordinal number p being one integer not less than 1 and not more than N,

an ordinal number q being one integer not less than 1 and not more than N,

the ordinal number q being different from the ordinal number p,

a parameter aₚ being different from a parameter a_{q}.

### Configuration 22

A calculation method, comprising:

causing a processor to perform repeating an update processing,

the update processing including an update of a first variable set and an update of a second variable set,

the first variable set including a first variable xᵢ (the ordinal number i being an integer of 1 to N, and N being one integer not less than 2),

the second variable set including a second variable yᵢ,

the update of the second variable set including updating the second variable yᵢ by adding a second function Fᵢ to the second variable yᵢ before the update,

the second function Fᵢ including the first variable xᵢ as a variable,

the second function Fᵢ including a parameter aᵢ,

an ordinal number p being one integer not less than 1 and not more than N,

an ordinal number q being one integer not less than 1 and not more than N,

the ordinal number q being different from the ordinal number p,

a parameter aₚ being different from a parameter a_{q}.

According to embodiments, a calculating device, a calculation program, a recording medium, and a calculation method can be provided in which the calculation accuracy can be increased.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in calculating devices such as processors, acquisition parts, holding parts, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all calculating devices, calculation programs, recording media, and calculation methods practicable by an appropriate design modification by one skilled in the art based on the calculating devices, the calculation programs, the recording media, and the calculation methods as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A calculating device, comprising:
a processor configured to perform repeating an update processing,
the update processing including an update of a first variable set and an update of a second variable set,
the first variable set including a first variable xᵢ (the ordinal number i being an integer of 1 to N, and N being one integer not less than 2),
the second variable set including a second variable yᵢ,
the update of the second variable set including updating the second variable yᵢ by adding a second function Fᵢ to the second variable yᵢ before the update,
the second function Fᵢ including the first variable xᵢ as a variable,
the second function Fᵢ including a parameter aᵢ,
an ordinal number p being one integer not less than 1 and not more than N,
an ordinal number q being one integer not less than 1 and not more than N,
the ordinal number q being different from the ordinal number p,
a parameter aₚ being different from a parameter a_{q}.

2. The device according to claim 1, wherein
the repeating of the update processing includes:
a first update; and
a second update performed after the first update, and
the parameter aₚ of the first update is different from the parameter aₚ of the second update.

3. The device according to claim 2, wherein
the processor performs the update processing K times (K being an integer not less than 2),
the parameter aᵢ of the Kth update processing is greater than the parameter aᵢ of the first update processing,
an absolute value of a difference between the first variable xₚ and a first value Aₚ is greater than an absolute value of a difference between the first variable x_{q} and a first value A_{q}, and
an increment of the parameter aₚ of the second update referenced to the parameter aₚ of the first update is less than an increment of the parameter a_{q} of the second update referenced to the parameter a_{q} of the first update.

4. The device according to claim 2, wherein
the processor performs the update processing K times (K being an integer not less than 2),
the parameter aᵢ of the Kth update processing is less than the parameter aᵢ of the first update processing,
an absolute value of a difference between the first variable xₚ and a first value Aₚ is greater than an absolute value of a difference between the first variable x_{q} and a first value A_{q}, and
a decrement of the parameter aₚ of the second update referenced to the parameter aₚ of the first update is less than a decrement of the parameter a_{q} of the second update referenced to the parameter a_{q} of the first update.

5. The device according to claim 2, wherein
the processor performs the update processing K times (K being an integer not less than 2),
the parameter aᵢ of the Kth update processing is greater than the parameter aᵢ of the first update processing,
an absolute value of a difference between a variable Zₚ and a first value Aₚ is greater than an absolute value of a difference between a variable Z_{q} and a first value A_{q},
an increment of the parameter aₚ of the second update referenced to the parameter aₚ of the first update is less than an increment of the parameter a_{q} of the second update referenced to the parameter a_{q} of the first update,
the variable Zₚ changes dependently on the first variable xₚ, and
the variable Z_{q} changes dependently on the first variable x_{q}.

6. The device according to claim 2, wherein
the processor performs the update processing K times (K being an integer not less than 2),
the parameter aᵢ of the Kth update processing is less than the parameter aᵢ of the first update processing,
an absolute value of a difference between a variable Zₚ and a first value Aₚ is greater than an absolute value of a difference between a variable Z_{q} and a first value A_{q},
a decrement of the parameter aₚ of the second update referenced to the parameter aₚ of the first update is less than a decrement of the parameter a_{q} of the second update referenced to the parameter a_{q} of the first update,
the variable Zₚ changes dependently on the first variable xₚ, and
the variable Z_{q} changes dependently on the first variable x_{q}.

7. The device according to claim 3, wherein
the processor controls the first variable xᵢ in a first range,
the first range is not less than a first boundary value and not more than a second boundary value, and
the first value Aₚ and the first value A_{q} are not less than the first boundary value and not more than the second boundary value.

8. The device according to claim 3, wherein
the processor controls the first variable xᵢ to be not less than a first boundary value and not more than a second boundary value, and
the first value Aₚ and the first value A_{q} are substantially median values of the first and second boundary values.

9. The device according to claim 3, wherein
the second function Fᵢ includes a first-term function, and
the first-term function includes a product of the first variable xᵢ and the parameter aᵢ.

10. The device according to claim 1, wherein
the second function Fᵢ includes a first-term function,
the first-term function includes a product of the first variable xᵢ, the parameter aᵢ, and a random number rᵢ,
the random number rᵢ is positive, and
a random number rₚ related to the ordinal number p is different from a random number r_{q} related to the ordinal number q.

11. The device according to claim 9, wherein
the second function Fᵢ includes the first-term function and a second-term function, and
the second-term function includes the first variable set and a first parameter set {J} as variables.

12. The device according to claim 11, wherein
the second-term function includes a multiply-add operation term of at least a part of the first parameter set {J} and at least a part of the first variable set.

13. The device according to claim 11, wherein
the processor includes a third processing part and a fourth processing part,
the third processing part performs a part of a calculation related to the second-term function,
the fourth processing part performs an other part of the calculation related to the second-term function, and
at least a portion of the other part of the calculation related to the second-term function is simultaneously performed with at least a portion of the part of the calculation related to the second-term function.

14. The device according to claim 9, wherein
the processor includes a first processing part and a second processing part,
the first processing part performs a part of a calculation related to the first-term function,
the second processing part performs an other part of the calculation related to the first-term function, and
at least a portion of the other part of the calculation related to the first-term function is simultaneously performed with at least a portion of the part of the calculation related to the first-term function.

15. The device according to claim 1, wherein
the update of the first variable set includes updating the first variable xᵢ by adding a first function to the first variable xᵢ before the update, and
the first function includes the second variable yᵢ as a variable.

16. The device according to claim 14, wherein
the processor includes a fifth processing part and a sixth processing part,
the fifth processing part performs a part of a calculation related to the first function,
the sixth processing part performs an other part of the calculation related to the first function, and
at least a portion of the other part of the calculation related to the first function is simultaneously performed with at least a portion of the part of the calculation related to the first function.

17. The device according to claim 15, wherein
the first function is independent of the first variable set, and
the second function is independent of the second variable set.

18. The device according to claim 1, wherein
the processor is configured to output at least the first variable xᵢ obtained after the repeating of the update processing and at least one function of the first variable xᵢ obtained after the repeating of the update processing.

19. A calculation program causing a computer to perform repeating an update processing,
the update processing including an update of a first variable set and an update of a second variable set,
the first variable set including a first variable xᵢ (the ordinal number i being an integer of 1 to N, and N being one integer not less than 2),
the second variable set including a second variable yᵢ,
the update of the second variable set including updating the second variable yᵢ by adding a second function Fᵢ to the second variable yᵢ before the update,
the second function Fᵢ including the first variable xᵢ as a variable,
the second function Fᵢ including a parameter aᵢ,
an ordinal number p being one integer not less than 1 and not more than N,
an ordinal number q being one integer not less than 1 and not more than N,
the ordinal number q being different from the ordinal number p, and
a parameter aₚ being different from a parameter a_{q}.

20. A calculation method, comprising:
causing a processor to perform repeating an update processing,
the update processing including an update of a first variable set and an update of a second variable set,
the first variable set including a first variable xᵢ (the ordinal number i being an integer of 1 to N, and N being one integer not less than 2),
the second variable set including a second variable yᵢ,
the update of the second variable set including updating the second variable yᵢ by adding a second function Fᵢ to the second variable yᵢ before the update,
the second function Fᵢ including the first variable xᵢ as a variable,
the second function Fᵢ including a parameter aᵢ,
an ordinal number p being one integer not less than 1 and not more than N,
an ordinal number q being one integer not less than 1 and not more than N,
the ordinal number q being different from the ordinal number p,
a parameter aₚ being different from a parameter a_{q}.
